(19) United States
(12) Patent Application Publication
(10) Pub. No.: US 2004/0051477 A1
(43) Pub. Date: Mar. 18, 2004

(54) Control device of gas-discharge light source

(76) Inventors: Alexander McBain, Ayr (GB); Aleksey Konstantinovich Bulanov, Ljubertsy (RU); Yevgenly Aleksandrovich Yermakov, Serpukhov (RU); Konstantin Lvovich Orlov, Moscow (RU); Vasiliy Sergeyevich Stupishin, Moscow (RU); Boris Viktorovich Uryvskiy, pos. Malakhova (RU)

Correspondence Address: JACOBSON HOLMAN PLLC, 400 SEVENTH STREET N.W., SUITE 600, WASHINGTON, DC, 20004, US

(21) Appl. No.: 10/415,110

(22) PCT Filed: Dec. 1, 2000
(86) PCT No.: PCT/RU00/00495

(30) Foreign Application Priority Data
Nov. 1, 2000 (RU) 2000127419

(51) Int. Cl. H05B 37/02

(52) U.S. Cl. 315/291; 315/224; 315/308

(57) ABSTRACT

The invention relates to electrical engineering.

The essence of the invention: a control device of gas-discharge light source having a resonant circuit with forked connection of a choke and capacitor, starting switch, an ignition pulse former, power-supply mains, control-and-command circuit with a microprocessor control unit having line-operated telemetric receiver and transmitter interacting with unit of timing and detector of frequency-modulated signals, elements of load state control, elements of current and voltage monitoring.

This invention relates to electrical engineering and in particular to supply devices for gas-discharge light sources.

Control devices of a gas-discharge light source containing a gas-discharge lamp as a load, resonant circuit functionally coupled with the load, igniting elements of the gas-discharge lamp with a controlled starting switch, power-supply mains and a control unit are known (JP, No. 6013977, H 02 M 7/48, 1985).

Known devices have a limited adjustment range due to application of a stiff logic function of control.

A more perfect and the closest analogue of the applied invention is a control device of a gas-discharge light source having a gas-discharge lamp as a load, resonant circuit in the form of a choke and capacitor functionally coupled with the load, an ignition pulse former with a power controlled switch and L element coupled with the load, power-supply mains and control-and-command circuit formed by a microprocessor control unit with a driving pulse oscillator, elements of load state control, elements of current and voltage monitoring in power-supply mains and a starting switch with control driver of a switching element (U.S. Pat. No. 5,049,790, H 05 B 41/00, 1991).

The deficiency of the above device is low mass-dimension and power figures owing to the need to mismatch a resonant circuit and driving oscillator for stabilization of load parameters.

A technical result of the applied invention is to increase reliability and to improve mass-dimension and power figures.

This result is obtained with the control device of a gas-discharge light source concluding a gas-discharge lamp as a load, resonant circuit in the form of a choke and capacitor functionally coupled with the load, an ignition pulse former with a power controlled switch and L element coupled with the load, power-supply mains and control-and-command circuit formed by a microprocessor control unit with a driving pulse oscillator, elements of load state control, elements of current and voltage monitoring in power-supply mains and a starting switch with control driver of a switching element; thanks to the fact that the device is provided with a unit of timing with power-supply mains and detector of frequency-modulated signals inductively coupled with the timing unit and galvanically coupled with the microprocessor control unit; in so doing the microprocessor control unit is made with a line-operated telemetric receiver coupled to the lead terminal of the detector of frequency-modulated signals having output receiving buffer, and with the line-operated telemetric transmitter coupled to the lead terminals of the unit of timing with power-supply mains having input transmitting buffer; and functional load coupling of a choke and capacitor of the resonant circuit-is forked.

As well as due to the fact that the L element of the ignition pulse former is designed in the form of a transformer, in this case the secondary transformer winding is coupled in series with the resonant circuit choke and the load.

Along with the fact that the L element of the ignition pulse former is maid in the form of an inductance coil, in this case the resonant circuit choke is coupled in series with the load and inductively coupled with the inductance coil.

Together with the fact that the L element of the ignition pulse former and resonant circuit choke are designed in the form of transformers, in this case the primary winding of the choke is coupled inductively with the load and the secondary winding of the L element.

And also owing to the fact that the L element of the ignition pulse former is designed in the form of a transformer, in this case the secondary transformer winding is coupled in series with the load and the resonant circuit capacitor.

The nature of the applied invention is shown in Figures where:

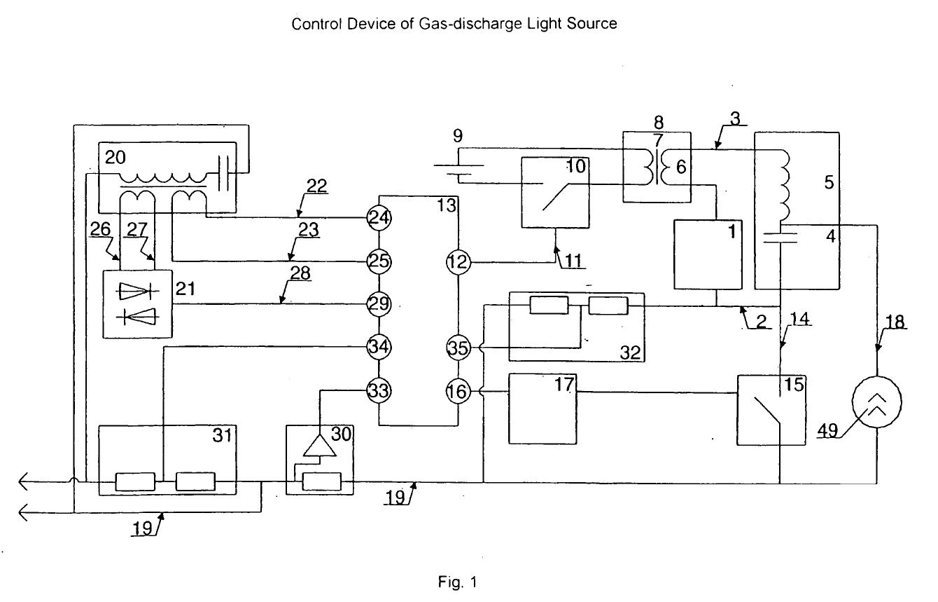

the circuit diagram of device with the L element of the ignition pulse former designed in the form of a transformer, in this case the secondary transformer winding is coupled in series with the resonant circuit choke and the load is given in FIG. 1;

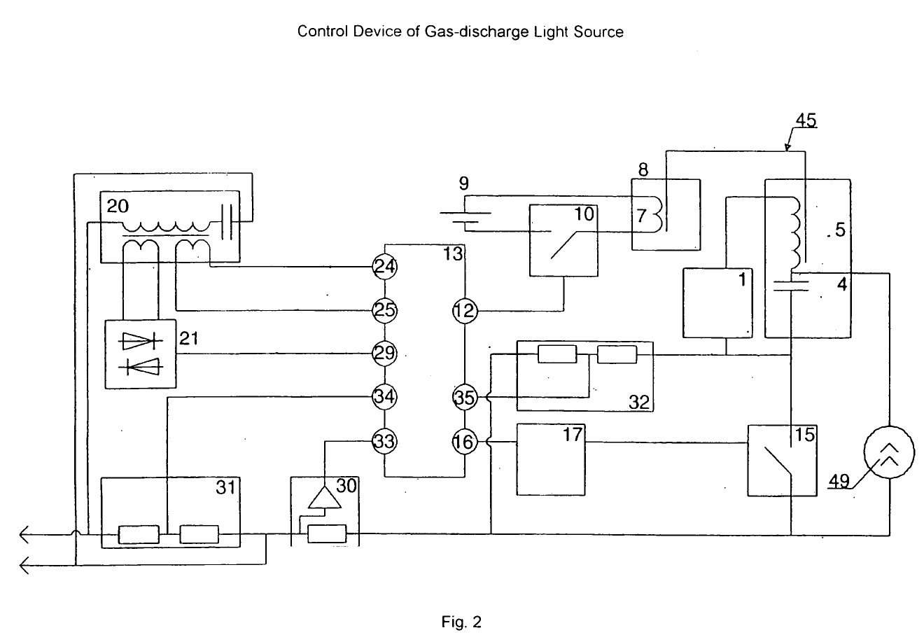

the circuit diagram of device with the L element of the ignition pulse former maid in the form of an inductance coil inductively coupled with the resonant circuit choke is given in FIG. 2;

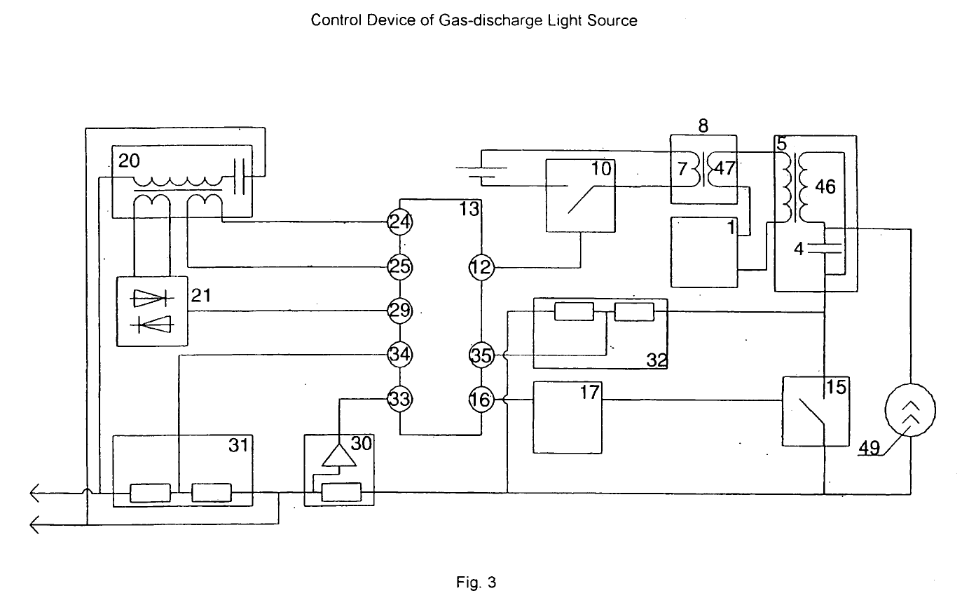

the circuit diagram of device with the ignition pulse former and resonant circuit choke designed in the form of transformers the secondary windings of which are coupled in series with the load is given in FIG. 3;

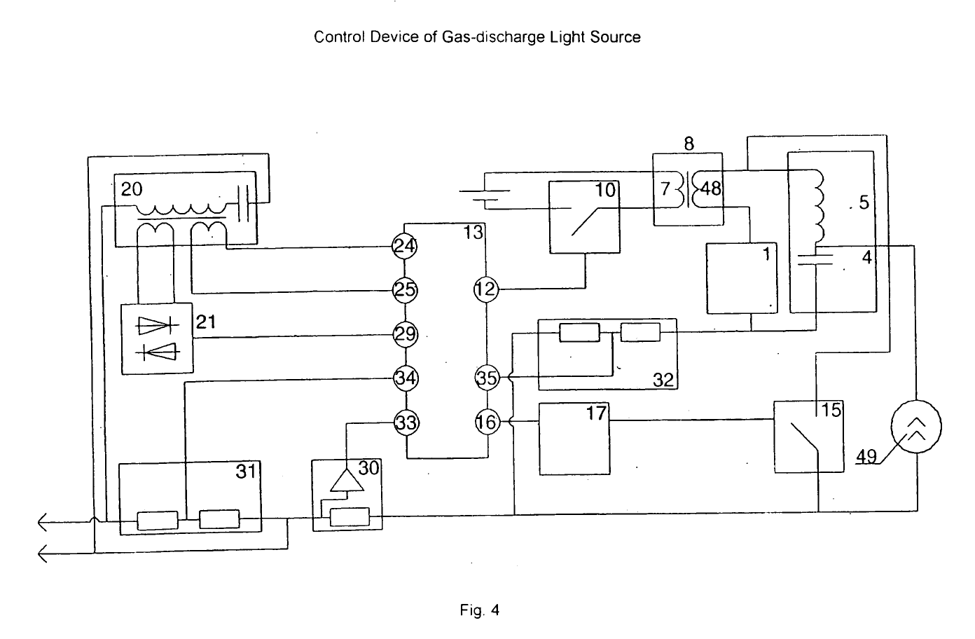

the circuit diagram of device with coupled in series load and resonant circuit capacitor the secondary windings of which is designed in the form of a transformer of the L element of the ignition pulse former is given in FIG. 4;

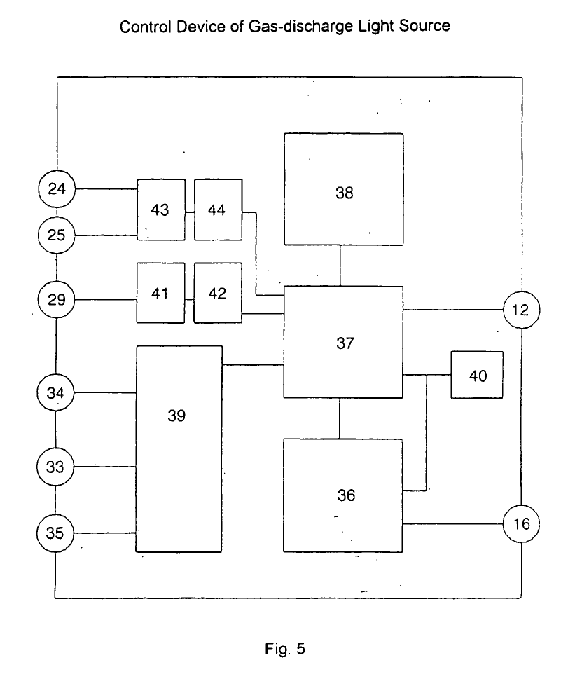

the block diagram of the microprocessor control unit is given in FIG. 5;

The device includes a load 1 having functional forked coupling (for example, lines 2 and 3 on the diagram in. FIG. 1) with capacitor 4 and choke 5 making a resonant circuit. On line 2 the secondary winding 6 (connected in series with the load 1 and choke 5) of the L element made in the form of a transformer 7 of an ignition pulse former 8. The given former is connected to a voltage source 9 through a power switch 10 with a control line 11 from terminal 12 of a microprocessor control unit 13.

Power supply of the load 1 and former 8 is provided by means of line 14 with a starting switch 15 with switching element controlled through terminal 16 of the microprocessor control unit 13 and control driver 17.

Power supply of the resonant circuit is provided on line 18 coming to the junction point of the choke 5 and capacitor 4 from a power supply source 49.

The device is equipped with a unit for timing with power supply mains 19 and detector 21 of frequency-modulated signals (for example, double-balanced phase detector on field-controlled transistors).

The first of them is coupled by means of lines 22 and 23 to terminals 24 and 25 of the microprocessor control unit 13, and the second one is coupled inductively by lines 26 and 27 with the timing unit 20, and coupled galvanically by line 28 with the microprocessor control unit 13 through terminal 29.

Elements for current and voltage monitoring in the form of a current sensor 30 and voltage sensor 31 are provided as a mean for obtaining check data on the power supply mains 19, and on line 2—elements for the load 1 state control in the form of a sensor 32 of circuit state.

Each of the intermediate sensors has connection with the microprocessor control unit 13; the sensor 30 through terminal 33, the sensor 31 through terminal 34 and the sensor 32 through terminal 35 correspondingly.

The microprocessor control unit 13 includes (see FIG. 5) a controlled driving pulse oscillator 36, arithmetic-logical unit 37, memory device 38, multichannel analog-to-digital converter 39 and reference frequency generator 40.

The microprocessor control unit 13 is designed with a line-operated telemetry receiver 41 connected to terminal 29 of the output of a frequency-modulated signals detector 21 and having a receiving buffer 42 at the output into the arithmetic-logical unit 37.

The microprocessor control unit 13 is also designed with a line-operated telemetry transmitter 43 connected to terminals 24 and 25 of the output of a timing unit 20 and having a transmitting buffer 44 at the output into the arithmetic-logical unit 37.

The device shown in FIG. 2 has the L element 7 of the ignition pulse former 8 designed in the form of an inductance coil inductively coupled through iron circuit 45 with the resonant circuit choke 5 coupled in series with the load 1. Such solution increases device reliability owing to reduction of electric couplings number.

The device shown in FIG. 3 has the L element 7 of the ignition pulse former 8 and resonant circuit choke 5 designed in the form of transformers, in this case the primary winding 46 of the choke 5 is coupled inductively with the secondary winding 47 of the L element 7 and with coupled with it in series the load 1. An advantage of this solution is simplicity of the device and load timing.

The device shown in FIG. 4 has the L element 7 designed in the form of a transformer with the secondary winding 48 coupled in series with the load 1 and the resonant circuit capacitor 4, as a result protection against passing direct current through the load is ensured.

Assemblage of the microprocessor control unit 13, sensors 30, 31 and 32, driver 17, starting switch 15 and their connections form a control-and-command circuit.

The device operates in the following way.

After supplying power feeding or pulsating voltage the microprocessor control unit 13 from time to time interrogates the current sensor 30, voltage sensor 31 and circuit state sensor 32. In case of coincidence of the received signals with the reference ones for transient state the microprocessor control unit 13 controlling power switch 10 of the ignition pulse former 8 supplies ignition pulse to the load. At the same time the control unit 13 supplies control repetitive pulse through driver 17 to the control input of the switching element of the starting switch 15. On the base of characteristic of signal from the circuit state sensor 32 the control unit 13 identifies circuit transition into steady state.

The control unit 13 performs transmission of data of device operation mode by lines of power supply mains 19 through the unit 20 of timing with power supply mains 19, and receives telecontrol commands through timing unit 20 and connected with it detector 21 of frequency-modulated signals. According to the telecontrol commands the control unit 13 changes current program settings determining operation conditions of the device and load parameters. In steady state the control unit 13 after the signal of a circuit state sensor 32, current sensor 30 and voltage sensor sets the period and width of control pulse as to prevent mismatch of the resonant circuit formed by forked connection of capacitor 4 and choke 5, driving oscillator 36 of the control unit 13 and in order to maintain stability of the set load parameters.

1. A control device of a gas-discharge light source having a gas-discharge lamp as a load, resonant circuit in the form of a choke and capacitor functionally coupled with the load, an ignition pulse former with a power controlled switch and L element coupled with the load, power-supply mains and control-and-command circuit formed by a microprocessor control unit with a driving pulse oscillator, elements of load state control, elements of current and voltage monitoring in power-supply mains and a starting switch with control driver of a switching element; this device is distinguishing due to the fact that it is provided with a unit of timing with power-supply mains and detector of frequency-modulated signals inductively coupled with the timing unit and galvanically coupled with the microprocessor control unit; in so doing the microprocessor control unit is made with a line-operated telemetric receiver coupled to the lead terminal of the detector of frequency-modulated signals having output receiving buffer, and with the line-operated telemetric transmitter coupled to the lead terminals of the unit of timing with power-supply mains having input transmitting buffer; and functional load coupling of a choke and capacitor of the resonant circuit is forked.

2. A device according to p.1, wherein a L element of the ignition pulse former is designed in the form of a transformer, in this case the secondary transformer winding is coupled in series with the resonant circuit choke and the load.

3. A device according to p.1, wherein a L element of the ignition pulse former is maid in the form of an inductance coil, in this case the resonant circuit choke is coupled in series with the load and inductively coupled with the inductance coil.

4. A device according to p.1, wherein a L element of the ignition pulse former and resonant circuit choke are designed in the form of transformers, in this case the primary winding of the choke is coupled inductively with the load and the secondary winding of the L element.

5. A device according to p.1, wherein a L element of the ignition pulse former is designed in the form of a transformer, in this case the secondary transformer winding is coupled in series with the load and the resonant circuit capacitor.
